(19) United States
(12) Patent Application Publication
(10) Pub. No.: US 2019/0171957 A1
(43) Pub. Date: Jun. 6, 2019

(54) SYSTEM AND METHOD FOR USER-LEVEL LIFETIME VALUE PREDICTION

(71) Applicant: Cognant LLC, Mountain View, CA (US)

(72) Inventors: Wei Yang, San Jose, CA (US); Yifan Zhao, Foster City, CA (US); Doug Loyer, San Jose, CA (US); Arun Kejariwal, Fremont, CA (US)

(21) Appl. No.: 16/208,773

(22) Filed: Dec. 4, 2018

Related U.S. Application Data
(60) Provisional application No. 62/595,233, filed on Dec. 6, 2017.

(51) Int. Cl. G06N 7/00; A63F 13/792; G06K 9/62; A63F 13/795

(52) U.S. Cl. CPC G06N 7/00; A63F 13/792; G06K 9/6282; A63F 2300/5513; A63F 2300/57; A63F 2300/5546; A63F 13/795

(57) ABSTRACT

A method, a system, and an article are provided for determining a lifetime value of a user of a client application. An example method includes: obtaining data including a history of interactions between a plurality of users and a client application on a plurality of respective client devices; developing, using the data, a first model to predict a likelihood that a new user of the client application will be a payer; developing, using the data, a second model to predict an amount of revenue generated by the new user of the client application; providing the client application to a plurality of new users; using the first model and the second model to predict the likelihood and the revenue for each new user in the plurality of new users; and adjusting, based on the predicted likelihood and the predicted revenue, a method of acquiring additional users of the client application.

### CROSS-REFERENCE TO RELATED APPLICATIONS

This application claims the benefit of U.S. Provisional Patent Application No. 62/595,233, filed Dec. 6, 2017, the entire contents of which are incorporated by reference herein.

### BACKGROUND

The present disclosure relates to software applications and, in particular, to systems and methods for determining a lifetime value of a user of a software application, such as a software application for a multiplayer online game.

In general, a multiplayer online game can be played by hundreds of thousands or even millions of players who use client devices to interact with a virtual environment for the online game. The players are typically working to accomplish tasks, acquire assets, or achieve a certain score in the online game. Some games require or encourage players to form groups or teams that can play against other players or groups of players. Players can gain a competitive advantage over other players by acquiring skills or assets that other players may not have. Such skills or assets can be acquired in some instances through user activity, transactions, and/or purchases in the multiplayer online game.

### SUMMARY

In general, the subject matter of this disclosure relates to predicting lifetime values of users of a software application, such as an application for a multiplayer online game. In various examples, one or more predictive models are developed based on data obtained for existing users of the online game. The models can be configured to predict a probability that a new user will make payments (e.g., purchases) in the online game. Users who make such payments can be referred to herein as “payers,” while users who do not make such payments can be referred to herein as “non-payers.” Additionally or alternatively, the models can be configured to predict an amount of revenue that a new user will generate in the online game (e.g., by making purchases). The lifetime value of a user can be or include an indication of payer or non-payer status and/or can include an indication of an amount of revenue generated by the user.

In some examples, the multiplayer online game can be provided on a plurality of client devices for a plurality of users. A history of user interactions with the online game can be obtained and used to develop a first predictive model and a second predictive model. The first predictive model can be configured to predict a likelihood that a new user of the game will be a payer. The second predictive model can be configured to predict an amount of revenue that will be generated by a new user of the game. The game can then be provided to a group of new users, and the first and second models can be used to predict the likelihood and the revenue for each new user. Based on the model predictions, adjustments can be made to a method of acquiring additional users of the game. For example, if the models indicate that the new group of users will have a low lifetime value, the systems and methods described herein can take corrective action to avoid attracting similar additional new users to the online game and/or to attract a different group of new users that has a higher lifetime value. Such corrective action can include, for example, adjusting a distribution of content presentations to prospective users of the online game and/or adjusting the content presented to the prospective users.

Advantageously, the systems and methods are able to predict lifetime values for new users shortly after the new users begin using the software application (e.g., within a few hours or within a day or two). This can allow the systems and methods to detect low lifetime values early and make any necessary corrections to ensure new users of the software application have sufficiently high lifetime values. Compared to any previous approaches, the systems and methods are able to make accurate predictions of user lifetime value much earlier in the user lifecycle. For example, previous approaches could require weeks or months after users begin using the software application before any accurate lifetime value data or predictions become available. The systems and methods described herein, however, can make accurate user lifetime value predictions within just a few hours of users beginning to use the software application.

In one aspect, the subject matter described in this specification relates to a computer-implemented method. The method includes: obtaining data including a history of interactions between a plurality of users and a client application on a plurality of respective client devices; developing, using the data, a first predictive model to predict a likelihood that a new user of the client application will be a payer; developing, using the data, a second predictive model to predict an amount of revenue generated by the new user of the client application; providing the client application to a plurality of new users; using the first predictive model and the second predictive model to predict the likelihood and the revenue for each new user in the plurality of new users; and adjusting, based on the predicted likelihood and the predicted revenue, a method of acquiring additional users of the client application.

In certain examples, the history of interactions includes a record of user activity in the client application. The data can include a record of user activity prior to installation of the client application. The data can include a user characteristic and/or a client device characteristic. The first predictive model and the second predictive model can each include a chain of predictive models, wherein each model in the chain is configured to make a prediction using data for a distinct user age. The predicted likelihood and the predicted revenue can include predictions for an initial time after the client application was first provided to the new user.

In some instances, using the first predictive model and the second predictive model includes extrapolating the predictions for the initial time to a later time using one or more multipliers. Using the first predictive model and the second predictive model can include providing the first predictive model and the second predictive model with input data including a history of interactions between the plurality of new users and the client application. The method of acquiring additional users can include presenting content related to the client application to a set of prospective additional users. The client application can include a multiplayer online game.

In another aspect, the subject matter described in this specification relates to a system having one or more computer processors programmed to perform operations including: obtaining data including a history of interactions between a plurality of users and a client application on a plurality of respective client devices; developing, using the data, a first predictive model to predict a likelihood that a new user of the client application will be a payer; developing, using the data, a second predictive model to predict an amount of revenue generated by the new user of the client application; providing the client application to a plurality of new users; using the first predictive model and the second predictive model to predict the likelihood and the revenue for each new user in the plurality of new users; and adjusting, based on the predicted likelihood and the predicted revenue, a method of acquiring additional users of the client application.

In certain implementations, the history of interactions includes a record of user activity in the client application. The data can include a record of user activity prior to installation of the client application. The data can include a user characteristic and/or a client device characteristic. The first predictive model and the second predictive model can each include a chain of predictive models, wherein each model in the chain is configured to make a prediction using data for a distinct user age. The predicted likelihood and the predicted revenue can include predictions for an initial time after the client application was first provided to the new user.

In some examples, using the first predictive model and the second predictive model includes extrapolating the predictions for the initial time to a later time using one or more multipliers. Using the first predictive model and the second predictive model can include providing the first predictive model and the second predictive model with input data including a history of interactions between the plurality of new users and the client application. The method of acquiring additional users can include presenting content related to the client application to a set of prospective additional users. The client application can include a multiplayer online game.

In another aspect, the subject matter described in this specification relates to an article. The article includes a non-transitory computer-readable medium having instructions stored thereon that, when executed by one or more computer processors, cause the computer processors to perform operations including: obtaining data comprising a history of interactions between a plurality of users and a client application on a plurality of respective client devices; developing, using the data, a first predictive model to predict a likelihood that a new user of the client application will be a payer; developing, using the data, a second predictive model to predict an amount of revenue generated by the new user of the client application; providing the client application to a plurality of new users; using the first predictive model and the second predictive model to predict the likelihood and the revenue for each new user in the plurality of new users; and adjusting, based on the predicted likelihood and the predicted revenue, a method of acquiring additional users of the client application.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for predicting a lifetime value of a user of a software application.

FIGS. 2 and 3 are schematic data flow diagrams of an example system for predicting a lifetime value of a user of a software application.

FIG. 4 is a flowchart of an example method of predicting a lifetime value of a user of a software application.

### DETAILED DESCRIPTION

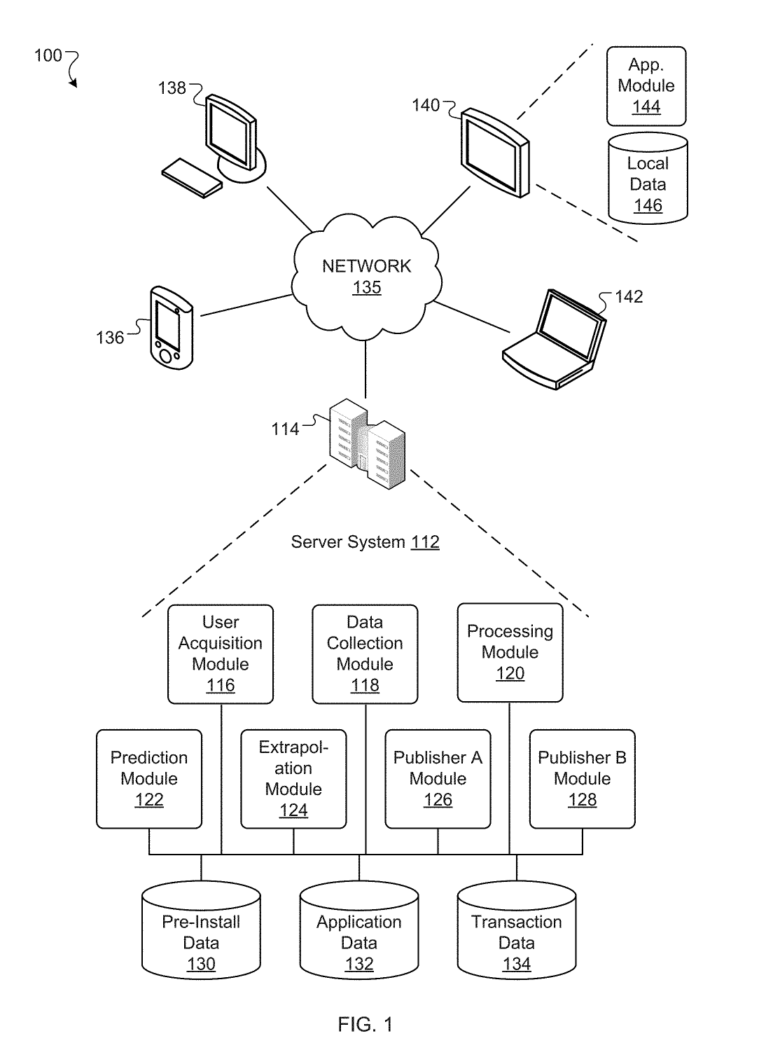

FIG. 1 illustrates an example system 100 for predicting a lifetime value of a user of a software application. A server system 112 provides functionality for collecting, processing, and analyzing data associated with users of the software application. The server system 112 includes software components and databases that can be deployed at one or more data centers 114 in one or more geographic locations, for example. In certain instances, the server system 112 is, includes, or utilizes a content delivery network (CDN). The server system 112 software components can include a user acquisition module 116, a data collection module 118, a processing module 120, a prediction module 122, an extrapolation module 124, a publisher A module 126, and a publisher B module 128. The software components can include subcomponents that can execute on the same or on different individual data processing apparatus. The server system 112 databases can include a pre-install data 130 database, an application data 132 database, and a transaction data 134 database. The databases can reside in one or more physical storage systems. The software components and data will be further described below.

A software application (also referred to herein as a “client application”), such as, for example, a web-based application, can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the software application provides a computer game, such as a multiplayer online game. The software application or components thereof can be accessed through a network 135 (e.g., the Internet) by users of client devices, such as a smart phone 136, a personal computer 138, a tablet computer 140, and a laptop computer 142. Other client devices are possible. In alternative examples, the pre-install data 130 database, the application data 132 database, the transaction data 134 database, or any portions thereof can be stored on one or more client devices. Additionally or alternatively, software components for the system 100 (e.g., the user acquisition module 116, the data collection module 118, the processing module 120, the prediction module 122, the extrapolation module 124, the publisher A module 126, and the publisher B module 128) or any portions thereof can reside on or be used to perform operations on one or more client devices.

Additionally or alternatively, each client device in the system 100 can utilize or include software components and databases for the software application. The software components on the client devices can include an application module 144, which can implement the software application on each client device. The databases on the client devices can include a local data 146 database, which can store data for the software application and exchange the data with the application module 144 and/or with other software components for the system 100, such as the data collection module 118. The data stored on the local data 146 database can include, for example, user data, user history data, user transaction data, image data, video data, and/or any other data used or generated by the system 100. While the application module 144 and the local data 146 database are depicted as being associated with the tablet computer 140, it is understood that other client devices (e.g., the smart phone 136, the personal computer 138, and/or the laptop computer 142) can include the application module 144, the local data 146 database, or any portions thereof.

FIG. 1 depicts the user acquisition module 116, the data collection module 118, the processing module 120, the prediction module 122, the extrapolation module 124, the publisher A module 126, and the publisher B module 128 as being able to communicate with the pre-install data 130 database, the application data 132 database, and the transaction data 134 database. The pre-install data 130 database generally includes data related to user characteristics (e.g., geographical location, gender, age, and/or other demographic information), client device characteristics (e.g., device model, device type, platform, and/or operating system), and/or a history of activity that existed or occurred prior to installation of the software application on the client devices. The history of activity can include, for example, information related to: content presentations on the client devices, user interactions with the content presentations, and publishers of the content presentations (e.g., websites and/or other applications). In general, the history can include information about how each user first installed and began using the software application. For example, the history of content presentations can be or include, for example, data summarizing each content presentation and any user interactions with the content presentations. Such data can include, for example, a device identifier, a publisher name and/or publisher identifier, a timestamp for a presentation time, a timestamp for a user interaction time, and/or similar data for each content presentation. The application data 132 database generally includes a history of user interactions with the software application. The user interactions can include, for example, user inputs to the client devices, user messages, user advancements (e.g., in an online game), user engagements with other users, and/or user assets. Data in the application data 132 database can be updated periodically, such as every minute, hour, or day. The transaction data 134 database generally includes a history of user transactions made in or with the software application. Such transactions can include, for example, user purchases, user sales, or similar activity, along with values (e.g., dollar amounts) for the transactions. In the context of an online game, transaction data can include a record of any purchases made by players, for example, to acquire virtual items, additional lives, new game features, or some other advantage.

In various examples, the user acquisition module 116 can be used to acquire new users of the software application. New users can be acquired, for example, by presenting digital content related to the software application on client devices of prospective users. In some instances, the digital content can be or include images, videos, audio, computer games, text, messages, offers, and any combination thereof. The digital content can encourage prospective users to download, install, and/or begin using the software application. The prospective users can interact with the digital content and be presented with opportunities to install and/or use the software application. In a typical example, the user acquisition module 116 can utilize one or more publishers (e.g., websites or other software applications) to present the digital content. The one or more publishers can be or include the publisher A module 126 and/or the publisher B module 128.

The data collection module 118 is generally configured to collect data that the system 100 uses to predict the lifetime value of users of the software application. The data collection module 118 can obtain data related to digital content presentations on client devices and any user interactions with the digital content. Additionally or alternatively, the data collection module 118 can obtain data related to user characteristics (e.g., geographical location, gender, age, and/or other demographic information), client device characteristics (e.g., device model, device type, platform, and/or operating system), and/or any user transactions with the software application. The data collection module 118 can provide the data to the pre-install data 130 database, the application data 132 database, and/or the transaction data 134 database. The data can be shared with other system components as described herein. In various examples, the data collection module 118 can utilize or include an attribution service provider. The attribution service provider can receive data or information from publishers related to the presentation of content and user actions in response to the content. The attribution service provider can determine, based on the information received, how to attribute the user actions to individual publishers.

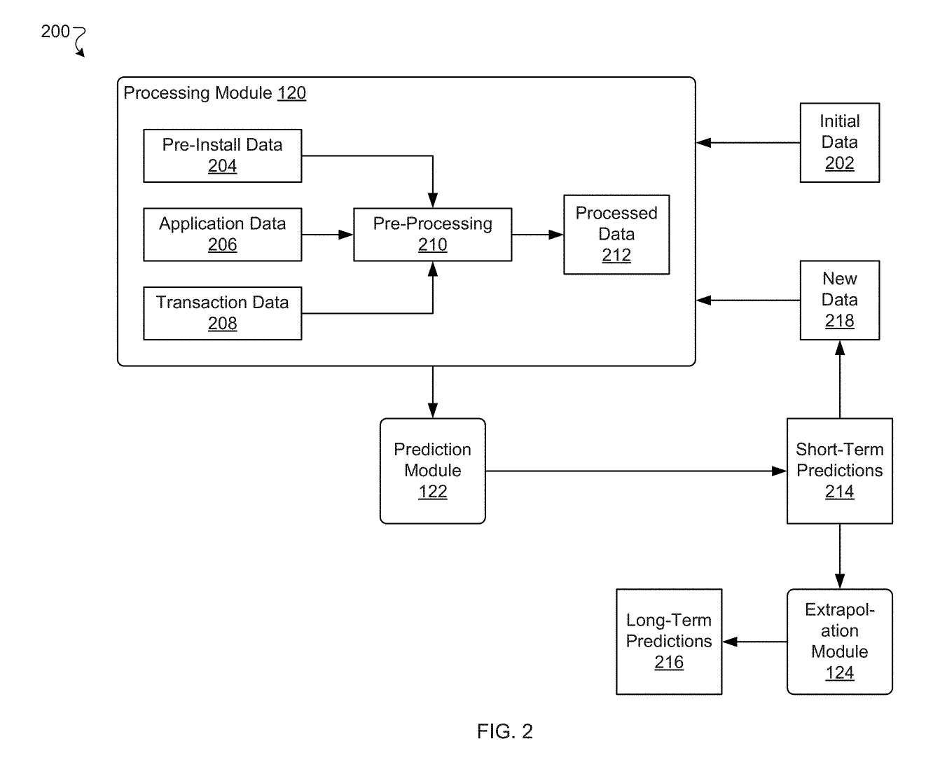

FIG. 2 illustrates an example system 200 in which the processing module 120 and the prediction module 122 are used to predict lifetime values for users of the software application. To begin, a set of initial data 202 is provided to the processing module 120. The initial data 202 generally includes pre-install data 204 (e.g., from the pre-install data 130 database), application data 206 (e.g., from the application data 132 database), and/or transaction data 208 (e.g., from the transaction data 134 database) for a set of users of the software application. The processing module 120 can preprocess (step 210) the pre-install data 204, the application data 206, and/or the transaction data 208 to generate a set of processed data 212 that can be used to train one or more predictive models (e.g., in the prediction module 122) and/or can be used as input to the one or more predictive models. The preprocessing step 210 can include data cleansing, user vectorization, and/or data merging, though other data processing can be performed. The data cleansing can include missing data imputation, one-hot encoding, or similar techniques. The cleansed data is preferably numerical and has no null values. The user vectorization can include transforming application data and/or transaction data from a daily or hourly level to a user level, such that a single vector of data can be obtained for each user. The data merging can include joining the cleansed and vectorized data to form a matrix in which each row represents a user.

In some instances, a small number of users can account for a large portion of the transactions or total revenue identified in the transaction data 208. To prevent the predictive models from being skewed by such users and/or to avoid inaccurate model predictions, the transaction data 208 can be adjusted to indicate that such users were associated with a lower number of transactions or a lower amount of revenue. For example, the total amount of revenue for each user can be capped at a maximum value.

Next, the processed data 212 can be provided to the prediction module 122, which can include or utilize one or more predictive models. The processed data 212 can be used by the prediction module 122 to train the predictive models. Additionally or alternatively, the processed data 212 can be used as input to the predictive models, which can provide one or more predictions of user lifetime value for the software application. In the depicted example, the prediction module 122 provides short-term predictions 214 for user lifetime value. The short-term predictions 214 can include, for example, a predicted likelihood that one or more users will become payers and/or a predicted amount of revenue generated by the one or more users. The short-term predictions 214 can correspond to a short time period (e.g., one week, one month, or other time period) after the one or more users first installed or began using the software application. For example, the predictive models can predict a likelihood that a user will become a payer within one week or one month of first beginning to use the software application. Additionally or alternatively, the predictive models can predict an amount of revenue that a user will generate in the software application within one week or one month of first beginning to use the software application.

Next, the short-term predictions 214 can be extrapolated to generate long-term predictions 216 using the extrapolation module 124. The long-term predictions 216 can include, for example, a predicted likelihood that one or more users will become payers within a long period of time (e.g., six months, one year, or other time period) after first installing or using the software application. Additionally or alternatively, the long-term predictions 216 can include a predicted amount of revenue that the one or more users will generate in the software application within the long period of time after first using the software application. To generate the long-term predictions 216 from the short-term predictions 214, the extrapolation module 124 can utilize one or more multipliers. The multipliers can be determined, for example, based on historical data for one or more parameters (e.g., in the pre-install data 204, the application data 206, and/or the transaction data 208), such as geographical location, device type, platform (e.g., iOS or ANDROID), etc. The historical data may indicate, for example, that long-term values are 50% higher than short-term values for a given parameter (e.g., geographical location) or combination of parameters. In such a case, the long-term predictions 216 can be proportional to the short-term predictions 214. Alternatively or additionally, the extrapolation module 124 can determine that the long-term predictions 216 may not be proportional to the short-term predictions 214. In that case, the extrapolation module 124 can use a different mathematical relationship or functional form (e.g., an exponential function or a polynomial) to derive the long-term predictions 216 from the short-term predictions 214. The mathematical relationship can include one or more parameters from the pre-install data 204, the application data 206, and/or the transaction data 208 (e.g., as independent variables).

Next, the short-term predictions 214 or a portion thereof can be added to a set of new data 218 for the processing module 120. The new data 218 can be or include, for example, the short term predictions 214 for a new group of users or a most recently acquired group of users. The new group of users can be, for example, a set of users that installed or began using the software application during one or more recent time periods, such as a previous hour, day, week, or other suitable time period. Additionally or alternatively, the new data 218 can include pre-install data 204, application data 206, and/or transaction data 208 for the new group of users. The processing module 120 can preprocess the new data 218 using the same or similar techniques that the processing module 120 used to preprocess the initial data 202. The preprocessed new data 218 can then be used to further train the one or more predictive models in the prediction module 122 and/or can be used as input to the predictive models. For example, the preprocessed new data 218 can be added or appended to the processed data 212, which can be used to retrain or refresh the one or more predictive models in the prediction module 122. In preferred examples, the system 200 can be run on a periodic basis (e.g., hourly, daily, or other suitable time period) using the most recent data for new users and the most recent model predictions. The short-term predictions 214 can be added to the new data 218 as a batch during each run.

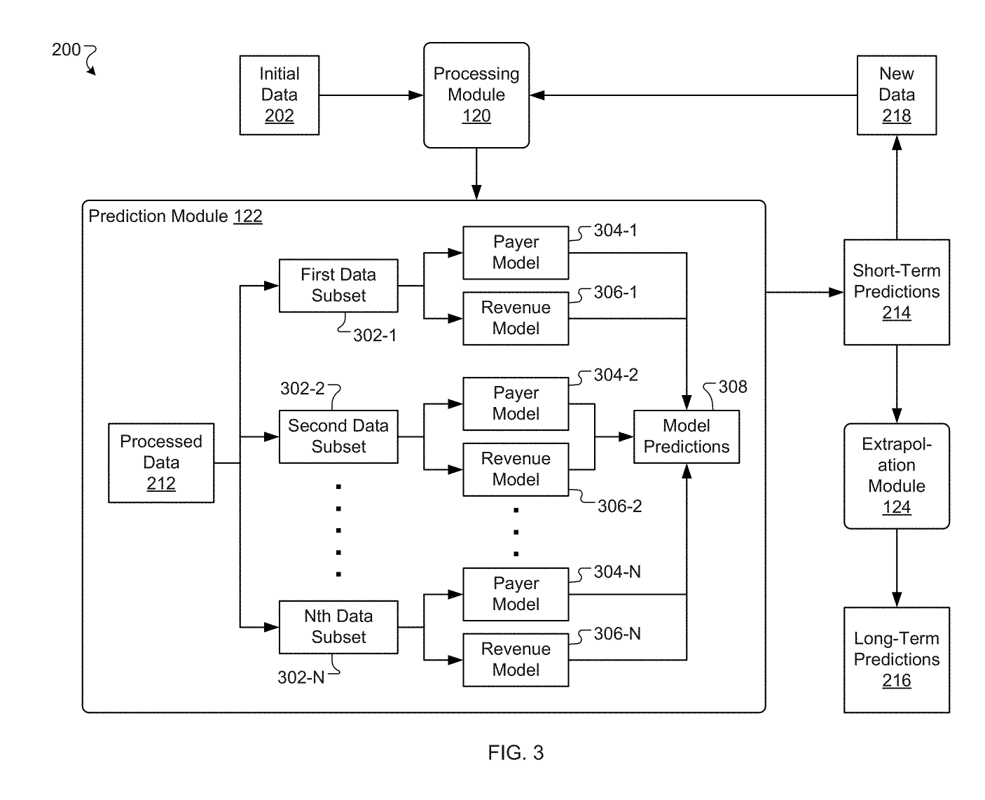

Referring also to FIG. 3, the prediction module 122 can include a collection of predictive models for predicting (i) the likelihood that users will be payers for the software application and/or (ii) an amount of revenue generated by users of the software application. The processed data 212 from the processing module 120 can be divided into subsets of data 302 in which each subset can correspond to, for example, a distinct user age, where user age is or represents a length of time since a user first installed or began using the software application. For example, a user who installed or began using the software application yesterday can have a user age of one day. In preferred examples, preprocessed data 212 for users having a first user age (e.g., one day) can be added to a first subset of data 302-1, preprocessed data 212 for users having a second user age (e.g., two days) can be added to a second subset of data 302-2, and so on, to form a total of N subsets of data, where N can be any integer greater than one. For example, an Nth subset of data 302-N can include preprocessed data 212 for users having a user age of N days. In some instances, user age can be measured in hours, weeks, months, or other units of time.

Each subset of data 302 can then be provided as input to one or more predictive models. In the depicted example, the predictive models for each subset of data 302 can include (i) a payer model 304 configured to predict the likelihood that a user will become a payer for the software application and (ii) and a revenue model 306 configured to predict the amount of revenue that a user will generate for the software application. The first subset of data 302-1 can be provided as input to the payer model 304-1 and the revenue model 306-1, which can then make predictions based on the input. Similar predictions can be made by the other predictive models, using the other subsets of data as input. The collection of payer models 304 and revenue models 306 described herein can be referred to as a chain of predictive models.

In preferred examples, each predictive model is tailored to make predictions for a specific user age. For example, the payer model 304-1 and the revenue model 306-1 can be tailored to make predictions for users having a user age corresponding to the first subset of data 302-1 (e.g., a user age of one day). Likewise, the payer model 304-2 and the revenue model 306-2 can be tailored to make predictions for users having a user age corresponding to the second subset of data 302-2 (e.g., a user age of two days). As a user advances in age, data for the user can be assigned to a new subset of data 302, which can be processed by a new payer model 304 and/or a new revenue model 306.

In various examples, each payer model 304 can be configured to predict a probability that a user, who is not currently a payer, will become a payer by the time the user reaches a target user age (e.g., one week or one month). For example, the payer model 304-1 can be used to predict the probability that a user having a user age of one day will become a payer by the time the user reaches a user age of one week. When the user is not already a payer, there is generally no transaction data 208 available for the user, so the payer model 304-1 can make the prediction based on any available pre-install data 204 and/or application data 206 for the user. Likewise, the payer model 304-2 can be used to predict the probability that a user having a user age of two days will become a payer by the time the user reaches the user age of one week. Additional payer models 304 can be used to predict payer probability as the user advances in age. In general, as more application data 206 is collected for the user, the models can receive more information as input and can provide more accurate predictions. For example, payer model 304-N can make predictions based on N days of application data 206 and generally will be more accurate (e.g., based on root-mean-square error) than payer model 304-1, which may make predictions based on one day of data.

In some instances, a user may become a payer by making a transaction in the software application. In that case, the payer probability for the user is already known (e.g., 100%), and there is generally no need to use the payer models 304 for that specific user. Each user can be assigned a value indicating whether the user is a payer (e.g., payer value=1) or a non-payer (e.g., payer value=0).

Likewise, each revenue model 306 can be configured to predict an amount of revenue generated by a user in the software application by the time the user reaches the target user age (e.g., one week or one month). For example, the revenue model 306-1 can be used to predict the amount of revenue generated by a user, having a user age of one day, by the time the user reaches a target user age of one week. The revenue model 306-1 can make the prediction based on any available pre-install data 204, application data 206, and/or transaction data 208 for the user. Similarly, the revenue model 306-2 can be used to predict the amount of revenue generated by a user, having a user age of two days, by the time the user reaches the target user age of one week. Additional revenue models 306 can be used to predict revenue as the user advances in age. In general, as more application data 206 and/or transaction data 208 is collected for the user, the models can receive more information as input and can provide more accurate predictions. For example, revenue model 306-N can make predictions based on N days of application data 206 and/or transaction data 208 and generally will be more accurate (e.g., based on root-mean-square error) than revenue model 306-1, which may make predictions based on one day of data.

In various examples, when there are N payer models 304 and/or N revenue models 306, the target user age can correspond to a time period of N+1. For example, when N=6, there can be six payer models 304 and six revenue models 306 used to make predictions for user ages of 1, 2, 3, 4, 5, and 6 (e.g., in days). The target user age in this example can be N+1=7 (e.g., 7 days). The output from each payer model 304 and each revenue model 306 can be collected in a single batch of model predictions 308.

In general, the payer models 304 and the revenue models 306 can be used to perform regression or classification and are preferably tree-based, though other suitable models can be used. Tree-based learning algorithms are generally robust to outliers. Tree-based methods can split a feature space into distinct and non-overlapping regions, and the splits can be performed based on information gain. The approach can require relatively little data preparation compared to other algorithms. In a preferred approach, gradient boosting trees can combine weak learners (e.g., decision trees) in an additive and iterative manner, with a model in each iteration correcting a predecessor model. The payer models 304 and/or the revenue models 306 can be based on or can utilize, for example, gradient boosting trees, neural networks, and/or random forest, though other regression models or classifiers can be used.

Still referring to FIGS. 2 and 3, the system 200 can utilize the pre-install data 204, the application data 206, and the transaction data 208 as input. The pre-install data 204 can include features such as, for example, install platform (e.g., iOS or ANDROID), device model (e.g., iPhone 6), device country code, Internet Protocol (IP) country code, and the like. The pre-install data 204 can capture a user profile from before installation of the software application. The predictive models can weigh such data more heavily for new users and less heavily for older users. The application data 206 can capture a user profile based on user interactions with the software application. For purposes of illustration and not limitation, when the software application is for a computer game, such as a multiplayer online game, the application data 206 can include one or more game features including, but not limited to, total power (e.g., a measure of player influence over other players), user level, research complete (e.g., a measure of user skill level), and/or play minutes (e.g., a total time spent playing the game). As user age increases, the predictive models can weigh the application data 206 more heavily than the pre-install data 204. The application data 206 can become, for example, the most indicative factor for determining a user's future engagement in the software application, as well as the user's propensity to become a payer and/or generate revenue. The transaction data 208 can provide features that are unique to revenue prediction models and/or can form a time series of transactions for a user. Such features are important for older users who have been using the application for a certain time period. The present system also provides feedback on the selection of the above features. For example, by providing the short-term predictions in the new data 218, the system 200 can compare model predictions with actual payer and revenue determinations. Additionally or alternatively, the predictive models can be retrained based on the new data 218. This can allow the predictive models to learn the influences of the various input data types and evolve over time.

In general, the systems and methods described herein can be used to predict lifetime values (e.g., payer and/or revenue) for groups of users. For example, when a new group of users is predicted to have a low likelihood of becoming payers and/or is predicted to generate little or no revenue, the systems and methods can take corrective action to prevent acquisition of additional users who are similar to the new users. To take the corrective action, the short-term predictions 214 and/or the long-term predictions 216 can be provided to the user acquisition module 116. The user acquisition module 116 can then make adjustments to how new users are acquired. This can be achieved, for example, by targeting different types of prospective users and/or adjusting content presentations on client devices of prospective users. For example, the user acquisition module 116 can determine that a new group of users from a certain geographical location (e.g., a country or state) will have low lifetime values. In response, the user acquisition module 116 can stop targeting additional prospective users from that geographical location and/or can begin targeting additional prospective users in a different geographical location. Additionally or alternatively, the user acquisition module 116 can determine that a new group of users with a low lifetime value began using the software application after being exposed to a particular item of content (e.g., a video showing the software application). In such a case, the user acquisition module can make adjustments to the content being presented to prospective users. Such adjustments can include, for example, stopping or decreasing the presentation of one or more items of content, beginning or increasing the presentation of one or more items of content, and/or revising one or more items of content. Additionally or alternatively, the user acquisition module 116 can determine that a new group of users with a low lifetime value was introduced to the software application through content presented by a particular publisher (e.g., the publisher A module 126). In such a case, the user acquisition module 116 can stop utilizing that publisher to present content to prospective users.

Advantageously, by determining lifetime values for new users of the software application, the systems and methods described herein are able to take corrective action to ensure that any additional new users will have sufficient lifetime values. For example, the systems and methods can take action to ensure that the additional new users will, at least on average, be payers and/or generate a desired or threshold level of revenue for the software application. The collection of predictive models, described herein, can allow lifetime value predictions to be made soon after user acquisition and to be updated as the user interacts with the software application and additional user data is obtained, over time. Additionally or alternatively, the lifetime value predictions can be aggregated by any desired parameter or dimension, such as publisher, geographical location, and the like, thereby allowing lifetime values to be evaluated for each dimension. This can allow the user acquisition module 116 to take immediate, corrective action, as needed, based on the lifetime values associated with each dimension.

In some examples, the model predictions are used as feedback to further train the models and/or to take corrective action when new users have predicted low lifetime value (e.g., payer and/or revenue). In such a case, the approach can utilize a control mechanism by comparing the predicted lifetime value with a target lifetime value. Based on any error identified in the comparison, adjustments can be made to the user acquisition process (e.g., by the user acquisition module 116). For example, when the predicted lifetime value is far below the target lifetime value, the user acquisition module 116 can take corrective action in an effort to acquire different or additional types of users that have higher lifetime values. Such comparisons can be made each time the system is run (e.g., every hour, every 6 hours, every 12 hours, or every day) and new model predictions become available.

While preferred implementations for the prediction module 122 utilize multiple predictive models, as shown in FIG. 3, to predict both payer probability and revenue, in alternative implementations the prediction module 122 can utilize a single model to make such predictions. For example, the prediction module 122 can utilize a single predictive model to predict (i) the probability that a user will be a payer and/or (ii) the amount of revenue generated by the user. In such an instance, the single predictive model can receive input data for all user ages and provide the payer and revenue predictions for each user and/or for each user age group. For example, like the multiple predictive models described herein for FIG. 3, the single predictive model can make separate payer and revenue predictions for each user age group. The input data for the single predictive model can include the pre-install data 204, the application data 206, and/or the transaction data 208 for each user, as well as the user age of each user.

To extract actionable insights from big data, it can be important to leverage big data technologies so that processing of large volumes of data can be supported. Two key big data technologies that can be used for the systems and methods described herein include, but are not limited to, APACHE PIG and APACHE HBASE. APACHE PIG is, in general, a platform for analyzing large sets of data that takes advantage of high-level language to express data analysis programs and includes infrastructure for evaluating these programs. APACHE PIG can be used as part of the processing module 120. APACHE HBASE is, in general, a column-oriented key/value data store built to run on top of the HADOOP Distributed File System (HDFS). APACHE HBASE can be used as part of the processing module 120.

The systems and methods described herein are designed in a modular fashion that is extensible for adding new algorithms or adding new data parameters or performance indicators as features. For example, as new forms of data related to users are developed and/or obtained, the systems and methods can utilize the new data to make lifetime value predictions. This allows new, impactful algorithms, and/or feature engineering to be developed and used by the systems and methods in an efficient and independent manner.

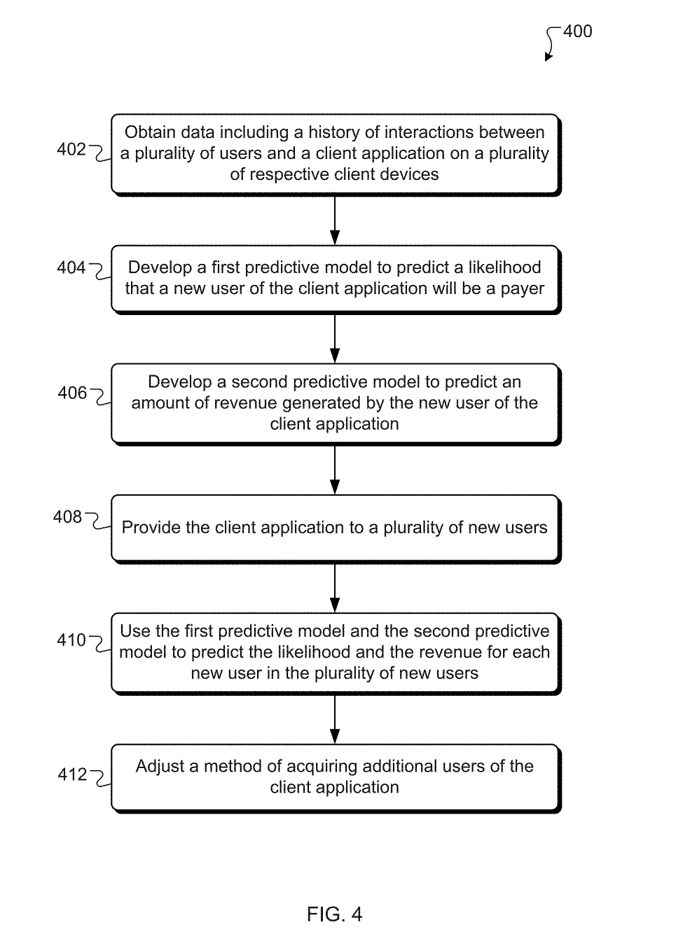

FIG. 4 illustrates an example computer-implemented method of determining lifetime value for users of a software application, such as a client application for a multiplayer online game. Data is obtained (step 402) that includes a history of interactions between a plurality of users and a client application on a plurality of respective client devices. Using the data, a first predictive model is developed (step 404) to predict a likelihood that a new user of the client application will be a payer, and a second predictive model is developed (step 406) to predict an amount of revenue generated by the new user of the client application. The client application is provided (step 408) to a plurality of new users. The first predictive model and the second predictive model are used (step 410) to predict the likelihood and the revenue for each new user in the plurality of new users. Based on the predicted likelihood and the predicted revenue, a method of acquiring additional users of the client application is adjusted (step 412).

In various examples, the systems and methods described herein can be used to predict the lifetime value of one or more users of a software application, such as a software application for an online game. This ability to predict lifetime value is important for several reasons. For example, in the mobile gaming context, users sharing similar in-game behavior might perform very differently in terms of revenue. Even the most engaged user can have less than a 30% chance of being a payer. Further, the amount of revenue generated by payers can vary significantly. In general, lifetime value predictions can be more accurate when more user data is used to make the predictions. For example, users with 6 hours of engagement data can generate more accurate predictions than with users with 4 hours of engagement data.

To attract new users to an online game, prospective users can be presented with one or more items of content that describe the game, for example, in the form of text, images, sounds, and/or video. The prospective users can interact with the content and can be provided with opportunities to install the online game on their client devices. The prospective users can be identified or defined through demographic segmentation. Demographics can separate prospective users by indicators such as, for example, age, gender, education level, and/or income. Once the prospective users have been identified, one or more publishers (e.g., websites and/or other software applications) can be used to present the items of the content to the prospective users. Lifetime value predictions can be used to select the publishers and/or choose the specific items of content.

Early lifetime value prediction is beneficial when using new publishers to present content to prospective users. Overuse of such publishers can bring low quality users to the software application, thereby potentially making return on investment negative. In contrast, underuse of such publishers can fail to attract more users, thereby resulting in scaling issues.

Advantageously, the systems and methods described herein can provide user-level lifetime value predictions by leveraging novel algorithms and big data platforms. The predictions can be used to extract actionable insights for reducing use of low quality publishers and increasing use of good quality publishers. The algorithmic-based approach described herein is generally auto-adaptive and able to account for a constantly evolving nature of publishers.

In particular, the systems and methods described herein can predict short-term user lifetime value (e.g., at a user age of 7 days) using a set of predictive models that receive various performance indicators or features as input. Some models can utilize a binary classification methodology, which can assign the probability of being a payer within, for example, 7 days (or other suitable time period) to each user. Based on regression analysis, the systems and methods can estimate the predicted revenue within, for example, 7 days for each user. Additionally or alternatively, the approach can utilize a fast feedback loop to incorporate or consider the most recent user behavior. For example, if a user did not make any purchases within 6 hours of install, a pay probability can be assigned. If the user also makes no purchases during the next 6 hours, the pay probability can be updated according to the user behavior during that time. The same can be applied to the day 7 revenue prediction as well. Thus, the systems and methods can adjust the short-term user lifetime predictions in a timely fashion to enable early and appropriate responsive action to be taken. Long-term multipliers, which can be differentiated by source (e.g., platform, publisher, geographical location, etc.), can be applied to generate long-term user lifetime value predictions.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
obtaining data comprising a history of interactions between a plurality of users and a client application on a plurality of respective client devices;
developing, using the data, a first predictive model to predict a likelihood that a new user of the client application will be a payer;
developing, using the data, a second predictive model to predict an amount of revenue generated by the new user of the client application;
providing the client application to a plurality of new users;
using the first predictive model and the second predictive model to predict the likelihood and the revenue for each new user in the plurality of new users; and
adjusting, based on the predicted likelihood and the predicted revenue, a method of acquiring additional users of the client application.

2. The method of claim 1, wherein the history of interactions comprises a record of user activity in the client application.

3. The method of claim 1, wherein the data further comprises a record of user activity prior to installation of the client application.

4. The method of claim 1, wherein the data further comprises at least one of a user characteristic and a client device characteristic.

5. The method of claim 1, wherein the first predictive model and the second predictive model each comprise a chain of predictive models, wherein each model in the chain is configured to make a prediction using data for a distinct user age.

6. The method of claim 1, wherein the predicted likelihood and the predicted revenue comprise predictions for an initial time after the client application was first provided to the new user.

7. The method of claim 6, wherein using the first predictive model and the second predictive model comprises:
extrapolating the predictions for the initial time to a later time using one or more multipliers.

8. The method of claim 1, wherein using the first predictive model and the second predictive model comprises:
providing the first predictive model and the second predictive model with input data comprising a history of interactions between the plurality of new users and the client application.

9. The method of claim 1, wherein the method of acquiring additional users comprises presenting content related to the client application to a set of prospective additional users.

10. The method of claim 1, wherein the client application comprises a multiplayer online game.

11. A system, comprising:
one or more computer processors programmed to perform operations comprising:
obtaining data comprising a history of interactions between a plurality of users and a client application on a plurality of respective client devices;
developing, using the data, a first predictive model to predict a likelihood that a new user of the client application will be a payer;
developing, using the data, a second predictive model to predict an amount of revenue generated by the new user of the client application;
providing the client application to a plurality of new users;
using the first predictive model and the second predictive model to predict the likelihood and the revenue for each new user in the plurality of new users; and
adjusting, based on the predicted likelihood and the predicted revenue, a method of acquiring additional users of the client application.

12. The system of claim 11, wherein the history of interactions comprises a record of user activity in the client application.

13. The system of claim 11, wherein the data further comprises a record of user activity prior to installation of the client application.

14. The system of claim 11, wherein the first predictive model and the second predictive model each comprise a chain of predictive models, wherein each model in the chain is configured to make a prediction using data for a distinct user age.

15. The system of claim 11, wherein the predicted likelihood and the predicted revenue comprise predictions for an initial time after the client application was first provided to the new user.

16. The system of claim 15, wherein using the first predictive model and the second predictive model comprises:
extrapolating the predictions for the initial time to a later time using one or more multipliers.

17. The system of claim 11, wherein using the first predictive model and the second predictive model comprises:
providing the first predictive model and the second predictive model with input data comprising a history of interactions between the plurality of new users and the client application.

18. The system of claim 11, wherein the method of acquiring additional users comprises presenting content related to the client application to a set of prospective additional users.

19. The system of claim 11, wherein the client application comprises a multiplayer online game.

20. An article, comprising:
a non-transitory computer-readable medium having instructions stored thereon that, when executed by one or more computer processors, cause the one or more computer processors to perform operations comprising:
obtaining data comprising a history of interactions between a plurality of users and a client application on a plurality of respective client devices;
developing, using the data, a first predictive model to predict a likelihood that a new user of the client application will be a payer;
developing, using the data, a second predictive model to predict an amount of revenue generated by the new user of the client application;
providing the client application to a plurality of new users;
using the first predictive model and the second predictive model to predict the likelihood and the revenue for each new user in the plurality of new users; and
adjusting, based on the predicted likelihood and the predicted revenue, a method of acquiring additional users of the client application.
